(19) United States
(12) Patent Application Publication
(10) Pub. No.: US 2013/0127325 A1
(43) Pub. Date: May 23, 2013

(54) LIGHT EMITTING DEVICE

(71) Applicant: TE-SHENG CHEN, Chu-Nan (TW)

(72) Inventor: TE-SHENG CHEN, Chu-Nan (TW)

(73) Assignee: FOXSEMICON INTEGRATED TECHNOLOGY, INC., Chu-Nan (TW)

(21) Appl. No.: 13/301,796

(22) Filed: Nov. 22, 2011

(51) Int. Cl. H01J 7/24

(52) U.S. Cl. 313/46

(57) ABSTRACT

An exemplary light emitting device includes a base, a pair of leads fixed on the base, a light emitting element mounted on the base and electrically connected to the leads and an encapsulant attached on the base and sealing the light emitting element. The base has a plurality of heat conductive paths formed therein. The heat conductive paths extend from a bottom face to a top face of the base to conduct heat generated by the light emitting element from the top face to the bottom face of the base.

### BACKGROUND

1. Technical Field

The present disclosure relates to light emitting device, and more particularly, to light emitting device having a high heat conductive base.

2. Description of Related Art

As new type light source, LEDs are widely used in various applications, such as road lamps, traffic lamps, tunnel lamps, resident lamps and so on. An LED generates heat in operation thereof. As increasing in power that the LED consumes, more heat is generated by the LED. However, there is lack of effective method for rapidly and uniformly dissipating heat from the LED to the outside atmosphere environment. The heat, which cannot be timely dissipated, would be accumulated within the LED and thus cause malfunction or even damage of the LED.

What is needed, therefore, is a light emitting device which can overcome the limitations described above.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a cross sectional view of a light emitting device in accordance with a first embodiment of the present disclosure.

FIG. 2 is a cross sectional view of a light emitting device in accordance with a second embodiment of the present disclosure.

FIG. 3 is a cross sectional view of a light emitting device in accordance with a third embodiment of the present disclosure.

FIG. 4 is a cross sectional view of a light emitting device in accordance with a fourth embodiment of the present disclosure.

FIG. 5 is a cross sectional view of a light emitting device in accordance with a fifth embodiment of the present disclosure.

FIG. 6 is a cross sectional view of a light emitting device in accordance with a sixth embodiment of the present disclosure.

### DETAILED DESCRIPTION OF THE EMBODIMENTS

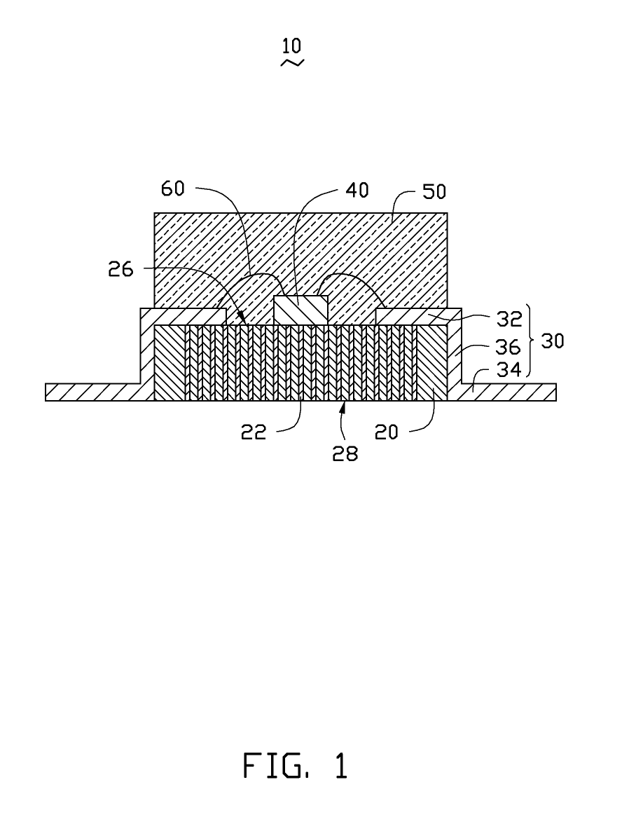

Referring to FIG. 1, a light emitting device 10 in accordance with a first embodiment of the present disclosure is shown. In this embodiment, the light emitting device 10 is an LED package. The light emitting device 10 includes a base 20, a light emitting element 40 mounted on a top face 26 of the base 20, a pair of leads 30 fixed on the base 20 and electrically connected to the light emitting element 40 and an encapsulant 50 sealing the light emitting element 40.

The base 20 is made of an electrically insulating material such as epoxy, silicon, ceramic or the like. The base 20 has a plurality of heat conductive paths 22 contained therein. Each heat conductive path 22 extends from a bottom face 28 to the top face 26 of the base 20. The heat conductive path 22 may be made of high heat conductive materials such as silver, copper, aluminum or other metals. The heat conductive paths 22 are uniformly spaced from each other so that two adjacent heat conductive paths 22 are not directly connected to each other. When the light emitting element 40 is operated to generate heat, the uniformly distributed heat conductive paths 22 can rapidly and evenly conduct the heat from the top face 26 to the bottom face 28 of the base 20, thereby increasing heat dissipation of the light emitting device 10.

The light emitting element 40 is disposed on a center of the top face 26 of the base 20 and in thermal contact with the heat conductive paths 22. In this embodiment, the light emitting element 40 is a light emitting chip made of GaN, InGaN, AlInGaN or other suitable light emitting semiconductor materials. The light emitting element 40 can be activated to emit light.

The pair of leads 30 are fixed at two opposite sides of the base 20. The pair of leads 30 are made of metal. Each lead 30 includes a top section 32 attached on the top face 26 of the base 20, a middle section 36 attached on a lateral face of the base 20 and a bottom section 34 extending outwardly and horizontally from the middle section 36. The top section 32 is parallel to the bottom section 34 and perpendicular to the middle section 36. The bottom section 34 is spaced from and coplanar to the bottom face 28 of the base 20. The top sections 32 of the two leads 30 are spaced from each other. The light emitting element 40 is located between and adjacent to the top sections 32 of the leads 30. The light emitting element 40 is electrically connected to the top sections 32 of the leads 30 via two wires 60, respectively. The leads 30 can introduce current into the light emitting element 40 from an external electrical power source.

The encapsulant 50 is molded on the top face 26 of base 20 to seal the wires 60 and the light emitting element 40. The encapsulant 50 may be made of transparent materials such as epoxy, silicon, glass or the like. The top sections 32 of the leads 30 are embedded within the encapsulant 50.

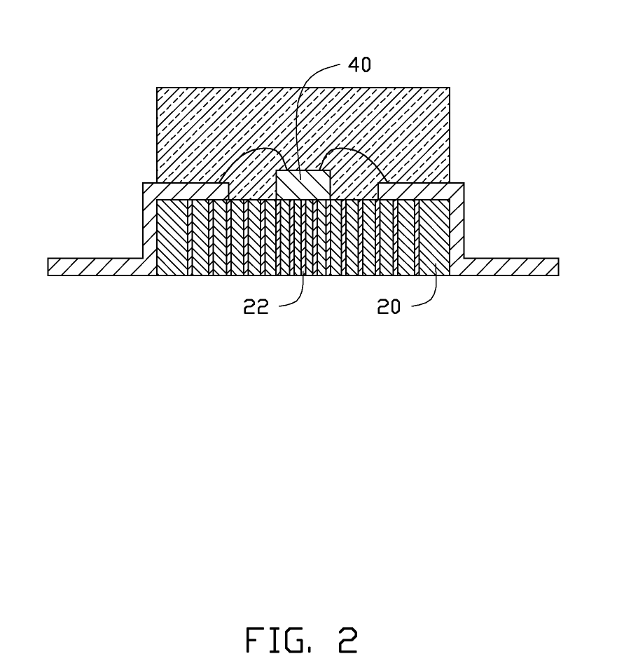

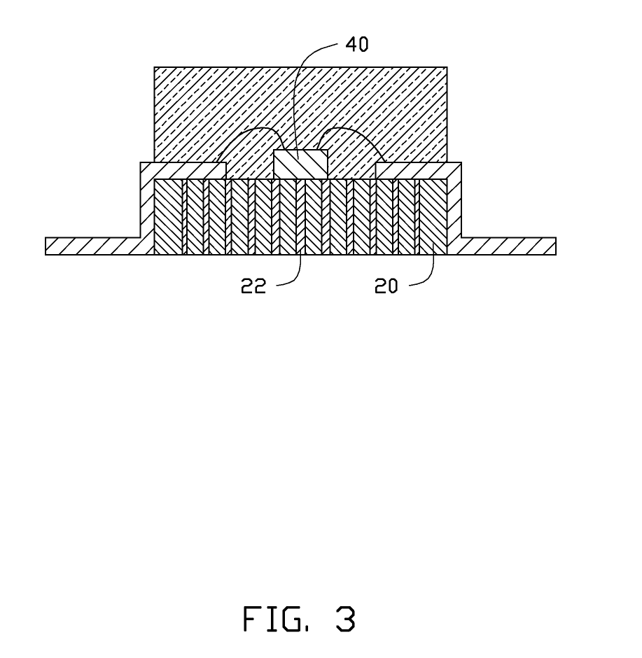

However, since an area of the base 20 adjacent to the light emitting element 40 suffers much more heat than areas of the base 20 away from the light emitting element 40, the configuration/arrangement of the heat conductive paths 22 can be varied for optimizing heat conduction of the base 20. For example, the heat conductive paths 22 adjacent to the light emitting element 40 can be arranged more densely than the heat conductive paths 22 away from the light emitting element 40 as shown in FIG. 2, or the heat conductive paths 22 can have gradually increasing widths from two lateral sides of the base 20 towards a center of the base 20 as shown in FIG. 3.

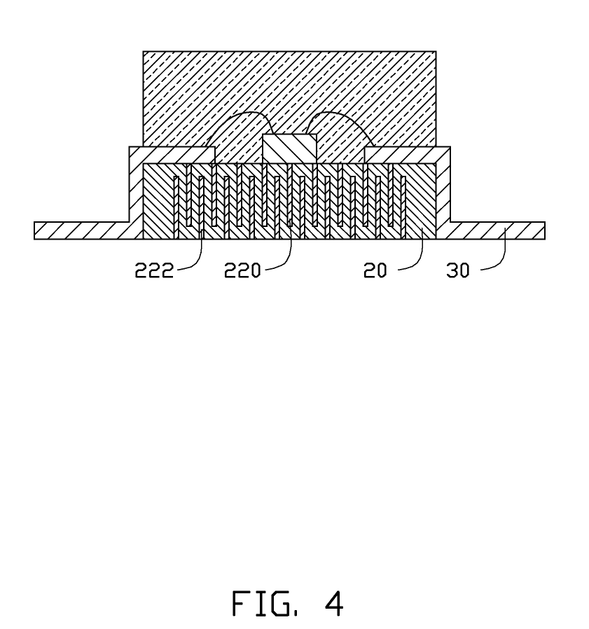

Furthermore, the heat conductive paths 22 are made of metal which is also electrical conductive. If the base 20 of the light emitting device 10 is placed on an outside metal heat sink having a supporting area similar to that of the bottom face 28 of the base 20 for heat dissipation, the heat conductive paths 22 located adjacent to the leads 30 may be in direct electrical connection with the leads 30 through the heat sink. The current delivered from one lead 30 would directly transmit to the other lead 30 through the heat conductive paths 22 and the heat sink, without passing through the light emitting element 40, thereby causing a short circuit of the light emitting element 40. In order to resolve such problem, the configuration and the arrangement of the heat conductive paths 22 can be further varied. As shown in FIG. 4, the heat conductive paths 22 are designed to include a plurality of first heat conductive paths 220 are second heat conductive paths 222 alternately arranged within the base 20. Each first heat conductive path 220 extends from the top face 26 of the base 20 and is terminated within the base 20 at a level above and adjacent to the bottom face 28 of the base 20. Each second heat conductive path 222 extends from the bottom face 28 of the base 20 and is terminated within the base 20 at a level below and adjacent to the top face 26 of the base 20. As a result, the heat conductive paths 22 cannot conduct current from the bottom face 28 to the top face 26 of the base 20, and the top face 26 of the base 20 is kept electrically insulating from the bottom face 28 of the base 20. Thus, the heat conductive paths 22 will not interfere with the normal electrical conduction of the leads 30.

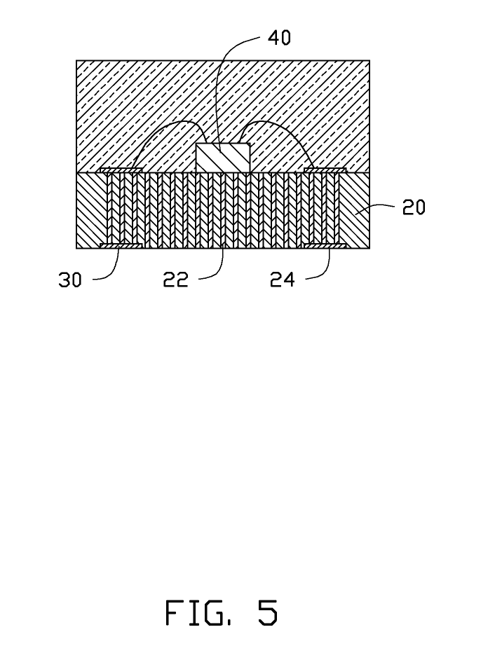

Alternatively, there is another method for resolving such problem. As shown in FIG. 5, the configuration of the each lead 30 is changed to include a pair of pads 24 formed on the top face 26 and the bottom face 28 of the base 20, respectively. The top pad 24 is flat and parallel to the bottom pad 24. The top pad 24 connects top ends of three heat conductive paths 22 adjacent to one lateral side of the base 20, and the bottom pad 24 connects bottom ends of the three heat conductive paths 22 adjacent to the lateral side of the base 20. The bottom pads 24 of the leads can be connected to the external electrical power to transfer the current into/out of the light emitting element 40 through the heat conductive paths 22 and the top pads 24. The configurations of the leads 30 can also prevent short circuit of the light emitting element 40 since the current is directed into the light emitting element 40 from the bottom face 28 of the base 20.

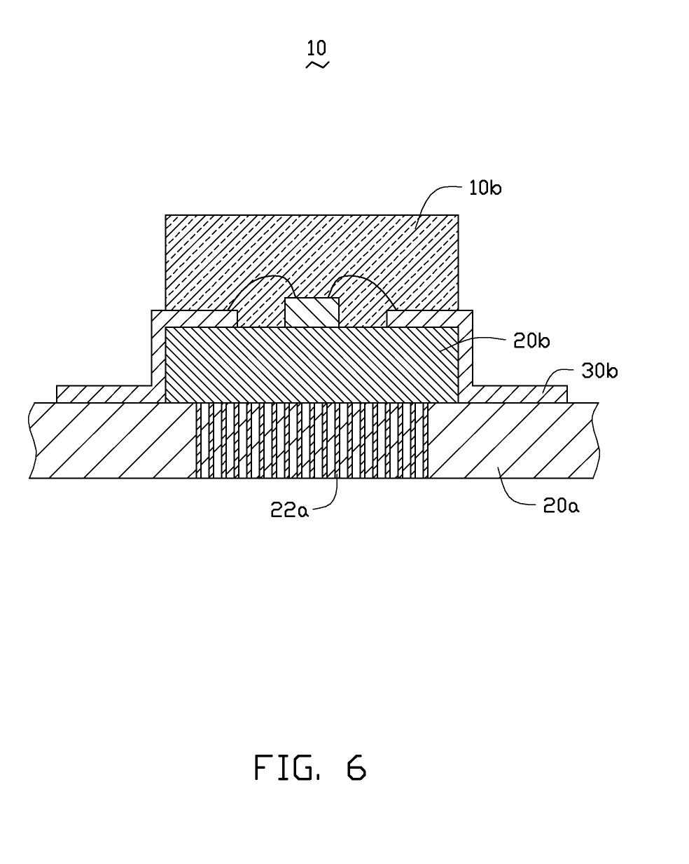

FIG. 6 shows another type light emitting device 10 different from that shown in FIGS. 1-5. The light emitting device 10 also includes a base 20a and a light emitting element 10b mounted on the base 20a. In this embodiment, the base 20a is a printed circuit board and the light emitting element 10b is an LED package. The light emitting element 10b may be any one of the five LED packages shown in FIGS. 1-5. The base 20a forms a plurality of heat conductive paths 22a therein for facilitating heat dissipation of the light emitting element 10b. The base 20b of the light emitting element 10b is attached on the base 20a above the heat conductive paths 22a, and the leads 30b of the light emitting element 10b is also attached on the base 20a to conduct current from the base 20a to the light emitting element 10b.

It is believed that the present disclosure and its advantages will be understood from the foregoing description, and it will be apparent that various changes may be made thereto without departing from the spirit and scope of the present disclosure or sacrificing all of its material advantages, the examples hereinbefore described merely being preferred or exemplary embodiments.

What is claimed is:

1. A light emitting device comprising:
a base comprising a plurality of spaced heat conductive paths received therein; and
a light emitting element mounted on a top face of the base, the heat conductive paths being in thermal contact with the light emitting element to conduct heat from the top face to a bottom face of the base.

2. The light emitting device of claim 1, wherein the heat conductive paths extend from the bottom face to the top face of the base, and the light emitting element directly contacts the heat conductive paths.

3. The light emitting device of claim 2, wherein the heat conductive paths are distributed more densely in a portion of the base adjacent to the light emitting element than a portion of the base away from the light emitting element.

4. The light emitting device of claim 2, wherein widths of the heat conductive paths are gradually increased from a position away from the light emitting element towards a position adjacent to the light emitting element.

5. The light emitting device of claim 2, wherein distances between adjacent heat conductive paths gradually decrease from a position away from the light emitting element towards a position adjacent to the light emitting element.

6. The light emitting device of claim 1, wherein the heat conductive paths comprise a plurality of first heat conductive paths and a plurality of second heat conductive paths alternately distributed with the first heat conductive paths, and the first heat conductive paths are extended from the top face of the base and terminated within the base at a level above and adjacent to the bottom face of the base.

7. The light emitting device of claim 6, wherein the second heat conductive paths are extended from the bottom face of the base and terminated within the base at a level below and adjacent to the top face of the base.

8. The light emitting device of claim 1 further comprising a pair of leads fixed on the base, wherein the leads are spaced from each other and electrically connected to the light emitting element.

9. The light emitting device of claim 8, wherein the heat conductive paths located away from the light emitting element connect the two leads, respectively.

10. The light emitting device of claim 9, wherein the leads each comprise a top section attached on the top face of the base, a middle section attached on a lateral face of the base and a bottom section extending outwardly from the middle section.

11. The light emitting device of claim 10, wherein the top section is parallel to the bottom section and perpendicular to the middle section.

12. The light emitting device of claim 10, wherein the top sections of the leads are connected to top ends of the heat conductive paths located away from the light emitting element.

13. The light emitting device of claim 9, wherein the leads each comprise two pads attached on the top face and the bottom face of the base, respectively.

14. The light emitting device of claim 13, wherein the two pads of the leads are connected to top ends and bottom ends of the heat conductive paths located away from the light emitting element, respectively.

15. The light emitting device of claim 1 further comprising an encapsulant attached on the base to seal the light emitting element.

16. The light emitting device of claim 1, wherein the base comprises a printed circuit board receiving the heat conductive paths therein, and the light emitting element comprises a light emitting diode package.

17. The light emitting device of claim 16, wherein the light emitting diode package comprises another base and a pair of leads fixed on the another base, the another base being disposed on the printed circuit board and located just above the heat conductive paths, the leads being fixed on and electrically connected to the printed circuit board.
